(19) United States
(12) Patent Application Publication
(10) Pub. No.: US 2011/0077819 A1
(43) Pub. Date: Mar. 31, 2011

(54) DATA MANAGEMENT DEVICE, DATA READING METHOD AND COMPUTER-READABLE MEDIUM

(75) Inventors: Masayuki SAKAGUCHI, Kobe-shi (JP); Kohhei ONO, Kobe-shi (JP)

(73) Assignee: FUJITSU TEN LIMITED, Kobe-shi (JP)

(21) Appl. No.: 12/891,110

(22) Filed: Sep. 27, 2010

(30) Foreign Application Priority Data
Sep. 30, 2009 (JP) 2009-228217

(51) Int. Cl. G06F 7/00

(52) U.S. Cl. 701/35

(57) ABSTRACT

A data management device manages data recorded by a drive recorder mounted in each of a plurality of vehicles. The drive recorder records operation data which represents a traveling situation of the vehicle and which does not include images and sounds and a plurality of kinds of contents data which includes at least one of images and sounds in one portable recording medium. A receiving unit receives a user setting regarding reading/non-reading of the contents data for each of the plurality of kinds. A storage device integrates and stores data obtained by the drive recorder of each of the plurality of vehicles. A reading unit reads the operation data and the contents data of a kind that is set for reading by the user setting among the plurality of kinds, among contents recorded in the recording medium by the drive recorder of the vehicle after completion of operation of each of the plurality of vehicles and records the operation data and the contents data in the storage device.

The disclosure of Japanese Patent Application No. 2009-228217 filed on Sep. 30, 2009, including specification, drawings and claims is incorporated herein by reference in its entirety.

### BACKGROUND

The present invention relates to a technique for reading data recorded by a drive recorder mounted in a vehicle.

In the related art, a drive recorder is known which constantly photographs the outside of a vehicle or the vehicle interior by a camera mounted in the vehicle and, when an event such as an accident occurs, records images acquired before and after the occurrence of the event in a portable recording medium, such as a memory card. A drive recorder or the like is also known which records not only images but also the traveling situation of a vehicle, such as the position, speed, acceleration, and the like of the vehicle, in a recording medium, or records images representing the situations of the outside of the vehicle or the vehicle interior in a recording medium in a predetermined cycle, regardless of events.

In recent years, in companies which carry out operations by using a plurality of vehicles for commercial use, such as trucks, buses, and taxis, a drive recorder is mounted in all of the vehicles which are used to carry out operations. In such companies, data acquired by the drive recorder of each vehicle is used for investigation of the causes of an accident, analysis of the driving tendencies of the driver, and guidance regarding the safe driving of the driver.

Patent Documents 1 and 2 describe a drive recorder which constantly photographs the vicinity of a vehicle by a vehicle-mounted camera, and records an image acquired at the time of occurrence of an accident in a recording medium. Patent Documents 3 and 4 describe a drive recorder which records data representing the traveling situation, such as vehicle speed, at the time of occurrence of an accident in a recording medium.
Patent Document 1: JP-A-63-16785
Patent Document 2: JP-A-06-237463
Patent Document 3: JP-A-06-331391
Patent Document 4: JP-A-06-186061

In recent years, there is a demand for drive recorders to be able to record images having higher resolution at a higher rate for a longer period of time. With such a demand, there is a considerable increase in the amount of data recorded in a recording medium of a drive recorder for each single operation of a vehicle.

In general, in companies which carry out operations by using vehicles such as trucks, buses, or taxis, data of a recording medium recorded by a drive recorder for each single operation wherein the vehicle departs from an establishment and returns to the establishment is latched into a data management device which is disposed in the establishment. As the amount of data recorded in the recording medium increases, the time required for latching the data into the data management device also increases accordingly. For example, if there is 2-GB data stored in the recording medium which is to be latched, it may take about 4 to 5 minutes to latch all of the data.

The data management device needs to latch data recorded by the drive recorder of each of a plurality of vehicles belonging to the establishment. Therefore, as the amount of data recorded by the drive recorder increases further in the future, it is expected that the data latching operation itself will take several hours when there are many vehicles belonging to the establishment. When the data latching operation takes such a long period of time, the work will be slowed accordingly. Thus, improvement is desired.

### SUMMARY

It is therefore an object of at least one embodiment of the present invention to provide a technique capable of shortening the processing time associated with a recording medium in which data is recorded by a drive recorder.

In order to achieve at least one of the above-described objects, according to a first aspect of the embodiments of the present invention, there is provided a data management device that manages data recorded by a drive recorder mounted in each of a plurality of vehicles, wherein the drive recorder records operation data which represents a traveling situation of the vehicle and which does not include images and sounds and a plurality of kinds of contents data which includes at least one of images and sounds in one portable recording medium, the data management device comprising: a receiving unit that receives a user setting regarding reading/non-reading of the contents data for each of the plurality of kinds; a storage device that integrates and stores data obtained by the drive recorder of each of the plurality of vehicles; and a reading unit that reads the operation data and the contents data of a kind that is set for reading by the user setting among the plurality of kinds, among contents recorded in the recording medium by the drive recorder of the vehicle after completion of operation of each of the plurality of vehicles and records the operation data and the contents data in the storage device.

With this configuration, the operation data which has a relatively small data size and the contents data of a kind that is set for reading among the contents data which has a relatively large data size are read. Therefore, reading of the contents data can be omitted according to need, and processing time associated with reading of the recording medium can be shortened.

The data management device may further comprise a deleting unit that deletes the operation data read by the reading unit from the recording medium.

With this configuration, whether or not reading of the recording medium has been completed in the data management device can be confirmed based on presence of the operation data in the recording medium.

The data management device may further comprise a deleting unit that deletes the contents recorded in the recording medium and read by the reading unit.

With this configuration, duplicate reading of the same data by the data management device can be prevented.

The operation data may include specific data for specifying a situation of the vehicle from which the contents data is acquired, and the data management device may further comprise a recording unit that records the specific data included in the operation data in the recording medium when the operation data is deleted from the recording medium.

With this configuration, since the specific data is recorded in the recording medium even when the operation data is deleted from the recording medium, the acquisition situation of the contents data remaining in the recording medium can be specified later.

The contents data may include specific data for specifying a situation of the vehicle from which the contents data is acquired.

With this configuration, since the contents data includes the specific data, the acquisition situation of the contents data remaining in the recording medium can be specified later.

The reading unit may further read contents data of which an acquisition situation meets a predetermined condition among the contents data of a kind that is set for non-reading by the user setting among the plurality of kinds.

With this configuration, since the contents data of which the acquisition situation meets a predetermined condition is exceptionally read even when the contents data is set for non-reading, important contents data can be recorded in the storage device.

The data management device further comprise an erasing unit that erases all of the contents data in the recording medium by selectively using a method of formatting the recording medium and a method of deleting files recorded in the recording medium.

With this configuration, when all of the contents data recorded in the recording medium is erased, by appropriately using the method of deleting the files rather than using the method of formatting the recording medium, the processing time associated with the recording medium can be shortened further.

The erasing unit may select one of the two methods in accordance with an operating system that runs on the data management device.

With this configuration, optimum processing can be selected in accordance with the operating system.

The erasing unit may select one of the two methods in accordance with the number of reading operations that the reading unit performed on the recording medium which is subjected to erasing.

With this configuration, by selectively using the method of formatting the recording medium and the method of deleting files recorded in the recording medium in accordance with the number of reading operations performed on the recording medium, inconveniences which may occur when the recording medium is not formatted can be prevented.

According to a second aspect of the embodiments of the present invention, there is provided a method of reading data recorded by a drive recorder mounted in each of a plurality of vehicles, wherein the drive recorder records operation data which represents a traveling situation of the vehicle and which does not include images and sounds and a plurality of kinds of contents data which includes at least one of images and sounds in one portable recording medium, the method comprising: receiving a user setting regarding reading/non-reading of the contents data for each of the plurality of kinds; reading the operation data and the contents data of a kind that is set for reading by the user setting among the plurality of kinds, among contents recorded in the recording medium by the drive recorder of the vehicle after completion of operation of each of the plurality of vehicles; and recording the operation data and the contents data in a storage device integrates and stores data obtained by the drive recorder of each of the plurality of vehicles.

According to a third aspect of the embodiments of the present invention, there is provided a computer-readable medium recording a program causing a computer to execute the method according to the second aspect of the embodiments of the present invention.

### BRIEF DESCRIPTION OF THE DRAWINGS

In the accompanying drawings:

FIG. 1 is a diagram showing the outline of a drive recorder system;

FIG. 2 is a diagram showing the configuration of a data management device;

FIG. 3 is a diagram showing the configuration of a drive recorder;

FIG. 4 is a diagram showing an example of a flow of an operation method of a memory card;

FIG. 5 is a diagram showing the storage state of data in a memory card;

FIG. 6 is a diagram showing a flow of data recording processing;

FIG. 7 is a diagram showing an example of a setup dialogue;

FIG. 8 is a diagram showing a flow of data latch processing;

FIG. 9 is a diagram showing a flow of all data erasing processing;

FIG. 10 is a diagram showing an example of a data region in a file;

FIG. 11 is a diagram showing a flow of a part of data latch processing of a third embodiment; and

FIG. 12 is a diagram showing a flow of all data erasing processing of a fourth embodiment.

### DETAILED DESCRIPTION OF THE EMBODIMENTS

Hereinafter, embodiments of the invention will be described with reference to the drawings.

### 1. First Embodiment

### 1-1. System Configuration

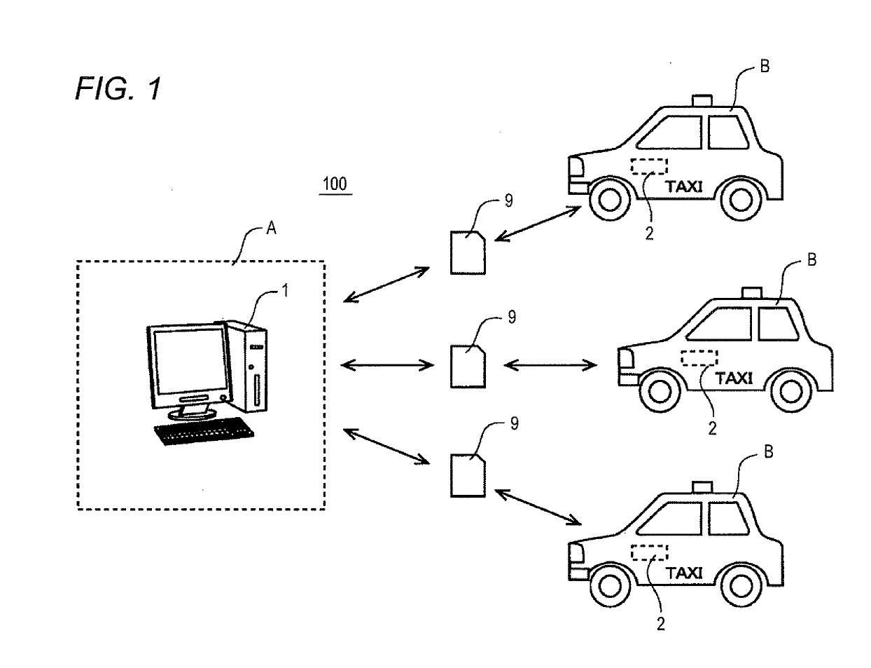

FIG. 1 is a diagram showing the outline of a drive recorder system 100 which includes a data management device 1 and a drive recorder 2. The drive recorder system 100 is used in a company which carries out operations by using a plurality of vehicles for commercial use, such as trucks, buses, and taxis. In this embodiment, description will be provided for a case where the drive recorder system 100 is used in a company which carries out operations by using taxis.

In this company, operations are carried out by using a plurality of vehicles B, including taxis, and the drive recorder 2 is mounted in each of the plurality of vehicles B. In an establishment A which manages a plurality of vehicles B, one data management device 1 is provided which manages and displays data recorded by the drive recorder 2. For data exchange between the data management device 1 and the drive recorder 2, a memory card 9 which is a portable recording medium is used. A flash memory which is a nonvolatile semiconductor memory is incorporated into the memory card 9.

The drive recorder 2 records various kinds of data regarding the operation of a vehicle B, in which the data recorder 2 is mounted, in the memory card 9. Specifically, if a certain event such as an accident occurs during the operation of the vehicle B, the drive recorder 2 records motion image data or sound data before and after the occurrence of the event. The drive recorder 2 also records operation data representing the traveling situation of the vehicle B, such as the position, speed, and acceleration of the vehicle, in a predetermined cycle. The drive recorder 2 also records image data and sound data representing the situations outside or inside the vehicle in a predetermined cycle as constantly recorded data, regardless of events.

Data which is recorded in the memory card 9 by the drive recorder 2 in each of a plurality of vehicles B is latched into the data management device 1 for each single operation of the vehicle B. The data management device 1 reads data recorded in the memory card 9 by the drive recorder 2 and records data in an internal nonvolatile storage device. Thus, data recorded by a plurality of vehicles B is collected in the data management device 1. In this description, the term “single operation” means that the vehicle B departs from the establishment A and comes back to the establishment A.

### 1-2. Configuration of Data Management Device

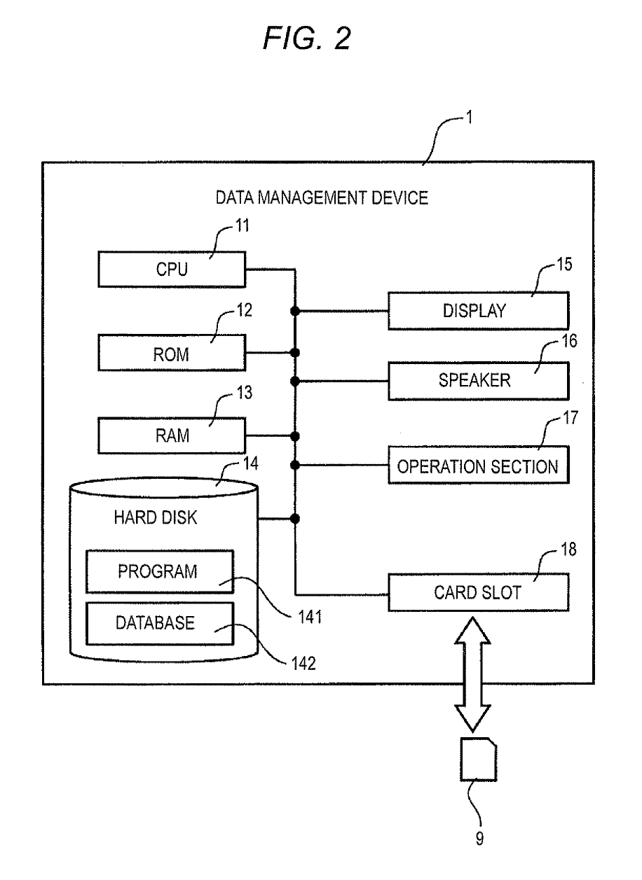

FIG. 2 is a diagram showing the configuration of the data management device 1. The hardware configuration of the data management device 1 is the same as the general computer. Specifically, the data management device 1 includes a CPU 11 which carries out various kinds of arithmetic processing, a ROM 12 which stores a basic program, a RAM 13 which serves as a work area of arithmetic processing, a hard disk 14 which is a nonvolatile storage device, a display 15 which performs various kinds of display, a speaker 16 which outputs sound, and an operation section 17 which is constituted by a keyboard and a mouse to be operated by the user. The data management device 1 is provided with a card slot 18 into which the memory card 9 is removably loaded. The card slot 18 reads data from the loaded memory card 9 or writes data in the memory card 9.

The hard disk 14 of the data management device 1 stores various programs 141. The CPU 11 carries out arithmetic processing in accordance with the programs 141, such that various functions necessary for the data management device 1 are implemented. The functions implemented by the programs 141 are, for example, an operating system or an exclusive-use application which handles data recorded by the drive recorder 2. The programs 141 are read from the recording mediums (for example, the memory card 9 and the like) in which the programs are recorded, or acquired by communication through a network, and are stored in the hard disk 14 in advance.

In the hard disk 14 of the data management device 1, a database 142 is constructed in which data recorded by the drive recorder 2 is collected. Data recorded in the memory card 9 by the drive recorder 2 is read through the card slot 18 and registered in the database 142. Data registered in the database 142 can be displayed on the display 15 as an image or output from the speaker 16 as sound by using an exclusive-use application. Data registered in the database 142 is also used in various kinds of analysis for safe driving guidance for the driver using the exclusive-use application.

### 1-3. Configuration of Drive Recorder

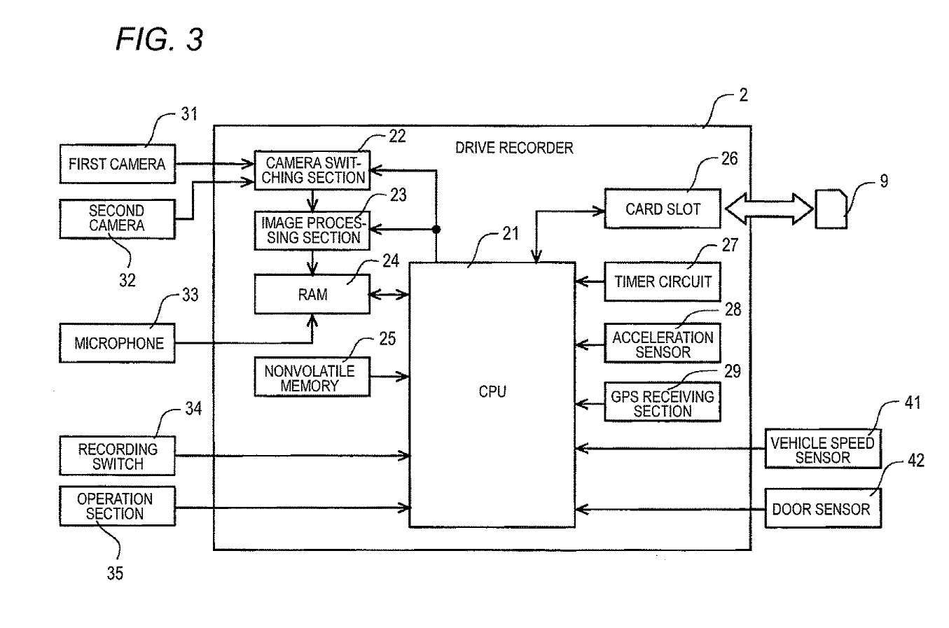

FIG. 3 is a diagram showing the configuration of the drive recorder 2. The drive recorder 2 includes a microcomputer which serves as a control section to control the entire device. Specifically, the drive recorder 2 includes a CPU 21 which carries out various kinds of arithmetic processing, a nonvolatile memory 25 which stores firmware, and a RAM 24 which serves as a work area of arithmetic processing. The CPU 21 carries out arithmetic processing in accordance with firmware stored in the nonvolatile memory 25 in advance, such that the function to control the respective sections of the drive recorder 2 is implemented. The nonvolatile memory 25 is, for example, constituted by a flash memory or the like, and stores various setup parameters and the like, in addition to firmware.

The drive recorder 2 includes two cameras 31 and 32 and a microphone 33 which are arranged at appropriate positions of the vehicle B separately from the main body portion of the drive recorder 2. Each of the two cameras 31 and 32 has a lens and an imaging element and electronically acquires image data. The first camera 31 has an optical axis which is directed forward in respect to the vehicle B outside the vehicle interior and acquires image data representing a region in front of the vehicle. The second camera 32 has an optical axis which is directed inward in respect to the vehicle interior and acquires image data representing the situation of the driver or passenger of the vehicle B. The microphone 33 collects sound outside and inside the vehicle interior to acquire sound data.

The drive recorder 2 includes a camera switching section 22 and an image processing section 23 which serve as a processing section to handle signals from the two cameras 31 and 32. The camera switching section 22 switches the signals input from the two cameras 31 and 32. The camera switching section 22 inputs the signal of image data of one of the two cameras 31 and 32 on the basis of an instruction from the CPU 21.

The image processing section 23 carries out predetermined image processing, such as A/D conversion, luminance correction, and contrast correction, for the signals input from the two cameras 31 and 32 to generate digital image data in a predetermined format, such as a PEG format. Image data processed by the image processing section 23 is recorded in the RAM 24.

A part of the storage area of the RAM 24 is used as a ring buffer. Image data processed by the image processing section 23 and sound data acquired by the microphone 33 are constantly stored in the ring buffer. If data is stored in the last area of the ring buffer, new data is stored in the first area. Thus, in the ring buffer, the oldest data is overwritten with new data. For this reason, image data and sound data for a predetermined time are constantly stored in the RAM 24. In this embodiment, image data and sound data for at least 40 seconds are stored in the ring buffer.

The drive recorder 2 also includes a card slot 26, a timer circuit 27, an acceleration sensor 28, and a GPS receiving section 29.

The card slot 26 is configured such that the memory card 9 is removably loaded thereinto. The card slot 26 reads data from the loaded memory card 9 or writes data in the memory card 9. When an event such as an accident occurs, image data and sound data stored in the ring buffer of the RAM 24 are recorded in the memory card 9 loaded into the card slot 26 in accordance with an instruction of the CPU 21.

The timer circuit 27 generates a signal corresponding to the time at that point of time and outputs the signal to the CPU 21. The timer circuit 27 has an internal battery and, even when power is not supplied from the outside, operates to measure an accurate time.

The acceleration sensor 28 detects acceleration representing the magnitude of an impact to the vehicle B in units of gravity acceleration G. The acceleration sensor 28 detects the magnitude of acceleration according to three or two orthogonal axes and outputs the magnitude to the CPU 21.

The GPS receiving section 29 receives signals from a plurality of GPS satellites and acquires information regarding the position of the vehicle B at that point of time. The GPS receiving section 29 acquires terrestrial position information expressed by latitude and longitude and outputs the acquired position information to the CPU 21.

The drive recorder 2 also includes a recording switch 34 and an operation section 35 which serve as a member to receive an instruction from the user (mainly, the driver of the vehicle B). These sections are arranged at appropriate positions of the vehicle B, such as the vicinity of the handle, separately from the main body portion of the drive recorder 2, such that the user can easily operate the sections.

The recording switch 34 is a switch which receives a recording instruction of motion image data in the memory card 9. In a situation where no accident occurs, the user presses the recording switch 34 to record motion image data in the memory card 9 with a desired timing. The operation section 35 includes a plurality of buttons and receives input regarding various settings from the user. The contents of operations by the user are input to the CPU 21 as signals.

The drive recorder 2 is connected to a vehicle speed sensor 41 and a door sensor 42 which are arranged in the vehicle B. The vehicle speed sensor 41 detects the traveling speed (km/h) of the vehicle B at that point of time and outputs the detected traveling speed to the CPU 21. The door sensor 42 is provided in any door of the vehicle B to output a signal indicating the open/closed state of the door to the CPU 21. The door sensor 42 is, for example, provided in a door of a rear seat side where the passenger of the vehicle B, such as a taxi, gets into or out.

### 1-4. Memory Card

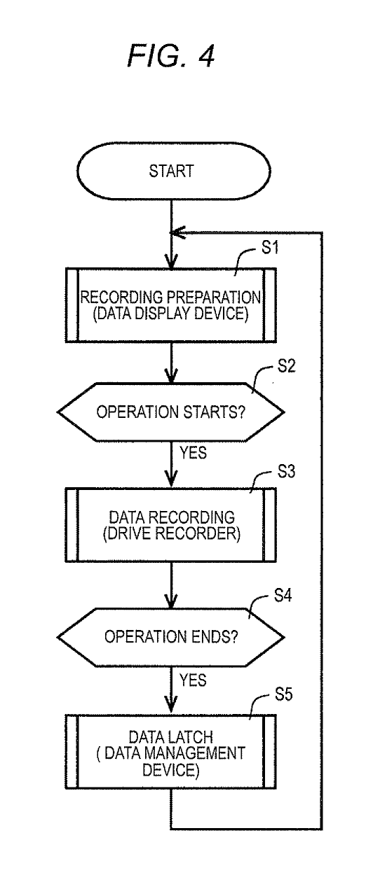

Next, an operation method of the memory card 9 in the drive recorder system 100 shown in FIG. 1 will be described. FIG. 4 is a diagram showing an example of a flow of an operation method of the memory card 9.

First, in the data management device 1, recording preparation processing is carried out as preparation for recording data of the drive recorder 2 in the memory card 9 (Step S1). The memory card 9 is formatted such that all of data are erased. Then, various setup parameters which should be set in the drive recorder 2 are recorded in the memory card 9.

The prepared memory card 9 is loaded in the drive recorder 2 of the vehicle B. If the vehicle B departs from the establishment A and starts to operate (Yes in Step S2), in the drive recorder 2, data recording processing is carried out for recording various kinds of data regarding the operation of the vehicle B in the memory card 9 during the subsequent operation of the vehicle B (Step S3).

Thereafter, if the operation of the vehicle B ends and the vehicle B comes back to the establishment A (Yes in Step S4), the memory card 9 is removed from the drive recorder 2 and loaded into the data management device 1. Then, in the data management device 1, data latch processing is carried out for latching data recorded in the memory card 9. Specifically, data recorded in the memory card 9 is read, converted in a predetermined format, and recorded in the database 142 of the hard disk 14 by the function of the exclusive-use application (Step S5).

The memory card 9 from which data is latched by the data management device 1 is again loaded into the drive recorder 2 of the vehicle B to be used to record various kinds of data regarding the operation of the vehicle B (Steps S2 and S3).

As described above, the memory card 9 is repeatedly used to record data by the drive recorder 2, and data recorded in the memory card 9 is latched to the data management device 1 for each single operation of the vehicle B. The data management device 1 carries out the data latch processing after the operations of a plurality of vehicles B belonging to the establishment A are completed.

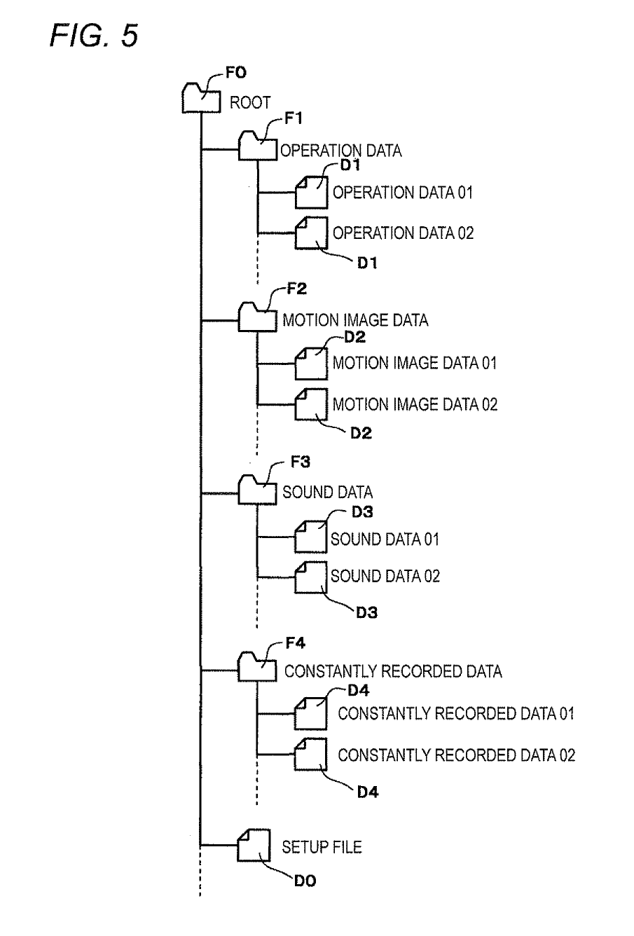

FIG. 5 is a diagram showing the storage state of data in the memory card 9. For the data storage structure in the memory card 9, a layered folder structure (layered directory structure) is used. Various kinds of data are stored in the folders. In FIG. 5, a character string next to a symbol representing a folder or data represents the name of the corresponding folder or data.

A “root” folder F0 is provided in the top layer of the layered folder structure. The “root” folder F0 stores a setup file D0 in which various setup parameters which should be set in the drive recorder 2 are recorded.

The “root” folder F0 is provided with subfolders, an “operation data” folder F1, a “motion image data” folder F2, a “sound data” folder F3, and a “constantly recorded data” folder F4.

The “operation data” folder F1 stores files D1 of operation data representing the traveling situation of the vehicle B, such as the position, speed, and acceleration of the vehicle B during the operation of the vehicle B. The files D1 of operation data are mainly constituted by text and do not include images and sound. Operation data is additionally recorded in the same file D1 in a predetermined cycle or under a predetermined condition. When the data size of the file D1 in which operation data should be recorded exceeds a predetermined size (for example, 1 megabyte), a new file D1 is created, and operation data is recorded in the new file D1. The files D1 of operation data include specific data for specifying the situation of the vehicle B in which the drive recorder 2 is mounted, such as the operation start time, identification information (ID code) of the vehicle B, and identification information (ID code) of the driver, in a header region.

The “motion image data” folder F2 stores files D2 of motion image data which is obtained when a predetermined event such as an accident occurs. Motion image data is, for example, constituted by image data and sound data for 12 seconds before an event occurs and 8 seconds after the event occurs, that is, for 20 seconds in total. A single file D2 is created for each event, and motion image data regarding one event is recorded as a single file D2.

The “sound data” folder F3 stores files D3 of sound data which is obtained when a predetermined even occurs. Sound data includes sound for 12 seconds before an event occurs and 8 seconds after the event occurs, that is, for 20 seconds in total. A single file D3 is created for each event, and sound data regarding one event is recorded as a single file D3.

In the drive recorder 2, a plurality of events are supposed in advance, and it is configured to set which of motion image data and sound data is recorded for each event. For this reason, when one kind of event occurs, motion image data is recorded, and when another kind of event occurs, sound data is recorded.

The “constantly recorded data” folder F2 stores files D4 of constantly recorded data which is constituted by image data and sound data obtained in a predetermined cycle during the activation of the drive recorder 2. During the activation of the drive recorder 2, image data and sound data are additionally recorded in the file D4 as constantly recorded data in a predetermined cycle, regardless of the occurrence of an event. When the data size of the file D4 in which constantly recorded data should be recorded exceeds a predetermined size (for example, 1 gigabyte), a new file D4 is created, and constantly recorded data is recorded in the new file D4.

As described above, in the drive recorder 2, four kinds of data including operation data, motion image data, sound data, and constantly recorded data are recorded. Among the four kinds of data, since the operation data does not include images and sound, the data size of the file is relatively small. On the other hand, since the motion image data, the sound data, or the constantly recorded data includes at least one of images and sound, the data size of the file is relatively large.

For example, a total data size of the file D1 of the operation data recorded in the memory card 9 is about 5 MB at maximum. In contrast, a total data size of the file D2 of the motion image data is about 1 KB at maximum, a total data size of the file D3 of the sound data is about 100 MB at maximum, and a total data size of the file D4 of the constantly recorded data is about 5 GB at maximum.

Given the above, the total data size of each of the motion image data, the sound data, and the constantly recorded data recorded in the memory card 9 is much larger than the total data size of the operation data. In the following description, the motion image data, the sound data, and the constantly recorded data, each of which includes at least one of images and sound will be collectively referred to as “contents data”.

### 1-5. Operation of Drive Recorder

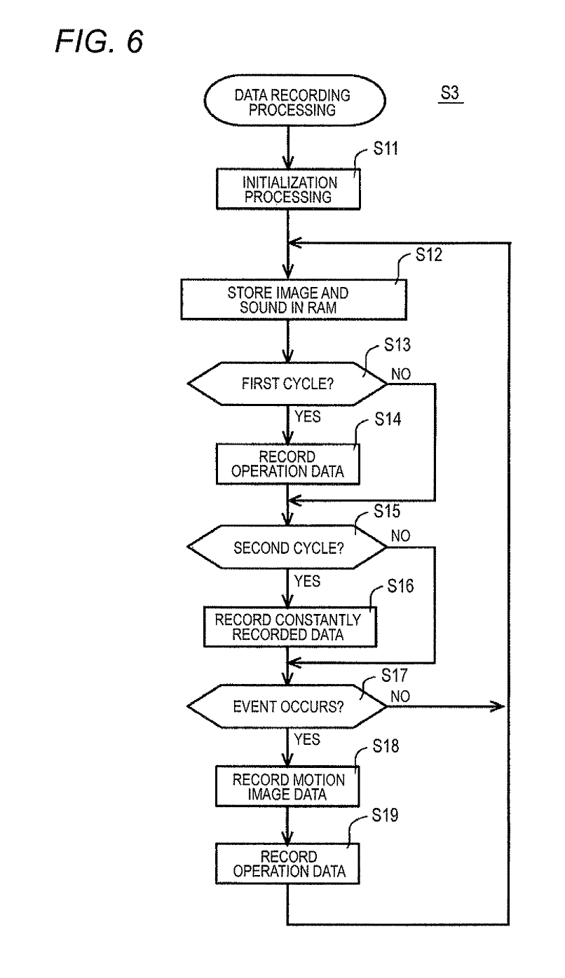

Next, the operation of the drive recorder 2 will be described. FIG. 6 is a diagram showing a flow of data recording processing (Step S3 of FIG. 4) in which the drive recorder 2 records various kinds of data in the memory card 9. At the time of the start of this operation, it is assumed that the memory card 9 is loaded into the card slot 26.

If the drive recorder 2 is activated, initialization processing is carried out under the control of the CPU 21 (Step S11). Specifically, first, it is confirmed whether there is a file D1 of operation data in the memory card 9 or not.

If there is no file D1 of operation data in the memory card 9, it is determined that the operation starts. Moreover, various setup parameters of a setup file D0 in the memory card 9 are read and stored in the nonvolatile memory 25, and the drive recorder 2 is set up in accordance with the setup parameters.

Subsequently, the folders F1 to F4 are created in the memory card 9 in which four kinds of data including operation data, motion image data, sound data, and constantly recorded data are respectively stored. Then, a file D1 of operation data is newly created in the “operation data” folder F1. In the header region of the file D1 of the operation data, specific data for specifying the situation of the vehicle B such as the operation start time, identification information of the vehicle B, and identification information of the driver is recorded. The time obtained by the timer circuit 27 at that point of time is used as the operation start time. Moreover, the information which is stored in advance in the nonvolatile memory 25 of the drive recorder 2 is read and used as the identification information of the vehicle B and the identification information of the driver.

At the time of the activation, if there is the file D1 of operation data in the memory card 9, it is determined as reactivation in the course of the operation, and setting of the drive recorder 2 and creation of the file D1 of operation data are omitted. However, if the driver is changed at that time, and when the identification information of the driver after change is input through the operation section 35, the identification information of that driver and the driver changing time are additionally recorded in the header region of the file D1 of the operation data as the specific data. The time obtained by the timer circuit 27 at that point of time is used as the driver changing time. The driver changing time and the identification information of the driver are a part of the specific data for specifying the situation of the vehicle B.

If the initialization processing is completed, image data obtained by the first camera 31 or the second camera 32 and sound data acquired by the microphone 33 start to be stored in the areas of the ring buffer of the RAM 24 (Step S12). Image data is stored in the RAM 24 at a frame rate of 30 fps (30 frames per second), for example. Subsequently, operation data and contents data are recorded in the memory card 9 under a predetermined condition (Steps S13, S15, and S17). Storing (Step S12) of image data and sound data in the RAM 24 is carried out until the drive recorder 2 stops during the activation of the drive recorder 2.

In Step S13, it is determined whether a predetermined first cycle in which operation data should be recorded is reached or not. If the first cycle is reached, operation data is recorded in the memory card 9 (Step S14). Thus, operation data is recorded in the memory card 9 for every ten seconds, for example. Operation data includes the position, speed, acceleration, and the like of the vehicle B at that point of time. Position information obtained by the GPS receiving section 29 is used as the position of the vehicle B, a traveling speed obtained by the vehicle speed sensor 41 is used as the speed of the vehicle B, and an acceleration obtained by the acceleration sensor 28 is used as the acceleration. Preferably, operation data includes various kinds of information regarding the operation or traveling of the vehicle B, such as the open/closed state of the door obtained by the door sensor 42, the operation situation of the recording switch 34, the lighting states of the lamps of the vehicle B, and the steering angle of the handle, in addition to the position, speed, and acceleration of the vehicle B.

In Step S15, it is determined whether a predetermined second cycle in which constantly recorded data should be recorded is reached or not. If the second cycle is reached, constantly recorded data is recorded in the memory card 9 (Step S16). Thus, constantly recorded data including image data and sound data is recorded in the memory card 9 for every one second, for example. As image data of constantly recorded data, single latest image data from among image data stored in the ring buffer of the RAM 24 is used. Therefore, the frame rate of image data of the constantly recorded data becomes 1 fps (1 frame per second).

In Step S17, it is determined whether a predetermined event occurs. When a predetermined event occurs, for example, image data and sound data for 12 seconds before the event occurs and 8 seconds after the event occurs, that is, for 20 seconds in total are read from the ring buffer of the RAM 24. Then, read image and sound data are used to generate single motion image data, and generated motion image data is recorded in the memory card 9 (Step S18). Further, operation data representing the situation of the vehicle B, such as the position, speed, and acceleration of the vehicle B, at the time of the occurrence of the event is recorded in the memory card 9 (Step S19).

In the drive recorder 2 of this embodiment, the conditions on which it is determined that a predetermined event occurs include the following conditions (A) to (D).

(A) When the acceleration sensor 28 continuously detects an acceleration equal to or higher than a predetermined value for a predetermined time or more. For example, when an acceleration equal to or higher than 0.40 G is continuously detected for 100 milliseconds or more.

(B) When the speed difference within a predetermined period of the vehicle B detected by the vehicle speed sensor 41 is equal to or greater than a threshold value. For example, when a deceleration for one second is equal to or higher than 14 km/h during traveling at a speed equal to or higher than 60 km/h.

(C) When the recording switch 34 is operated by the user.

(D) When the door sensor 42 detects the opening of the door.

The condition (A) refers to a situation where a comparatively high acceleration is generated and there is a high probability of occurrence of a collision accident of the vehicle B. The condition (B) refers to a situation where rapid deceleration is made and there is a high probability that an accident becomes urgent. The condition (C) refers to a situation where the user (mainly, the driver of the vehicle B) determines that data recording is required. The condition (D) refers to a situation where trouble is likely to occur and a passenger gets in or out.

The event occurrence conditions, such as the conditions (A) to (D), are just an example and may be arbitrarily changed by using the data management device 1. Further, sound data, instead of motion image data, may be recorded in accordance with the type of event occurring. For example, under the condition (D), only sound data may be recorded. When any event occurs, which of motion image data and sound data is recorded may be arbitrarily set by using the data management device 1.

### 1-6. Operation of Data Management Device

Next, the operation of the data management device 1 will be described. As described above, the data management device 1 carries out the data latch processing (Step S5 of FIG. 4) in which the data management device 1 reads data of the memory card 9 recorded by the drive recorder 2 and stores the data in the hard disk 14.

During the data latch processing, the data management device 1 is configured to read only contents data of a kind that is set for reading by a user rather than reading all of the three kinds of contents data without discrimination.

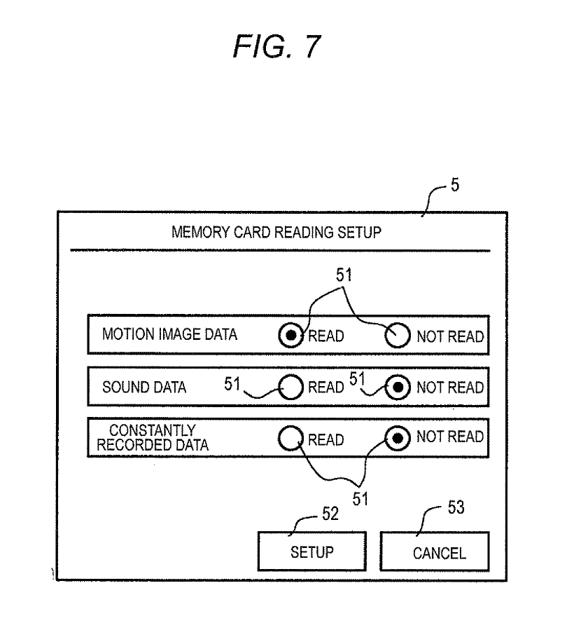

FIG. 7 is a diagram showing an example of a setup dialog 5 for carrying out setting as to reading of contents data. Such a setup dialog 5 is displayed on the display 15 by activating an exclusive-use application which handles data recorded in the drive recorder 2 and carrying out a predetermined operation.

In the setup dialog 5, each of three kinds of contents data (namely, motion image data, sound data, and constantly recorded data) is correlated to two operation buttons 51 of “read” and “not read.” The user is able to carry out setting as to reading/non-reading of each of the motion image data, the sound data, and the constantly recorded data by clicking these operation buttons 51.

When the user clicks a setup button 52 of the setup dialog 5 in a state where a desired one of the operation buttons 51 is clicked, the setting contents are recorded in the hard disk 14, and the data latch processing is carried out later in accordance with the setting contents. When the user clicks a cancel button 53 of the setup dialog 5, the setting contents are not changed but the previous setting contents are maintained.

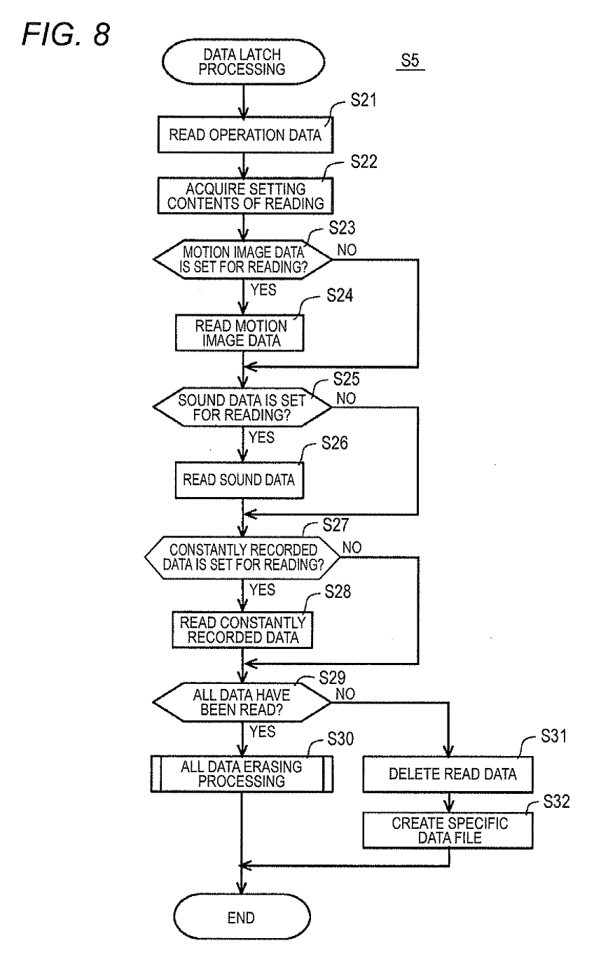

FIG. 8 is a diagram showing a flow of the data latch processing (Step S5 of FIG. 4) of the data management device 1. This processing is carried out by activating the exclusive-use application, which handles data recorded in the drive recorder 2, on the data management device 1 and carrying out a predetermined operation. At the time of the start of this processing, it is assumed that the memory card 9 is loaded into the card slot 18.

First, the file D1 of operation data is read from the memory card 9. The read operation data is converted into a format appropriate for registration and registered in the database 142 of the hard disk 14 (Step S21).

Subsequently, the setting contents as to reading/non-reading of each kind of contents data which is set up by the user using the setup dialog 5 (see FIG. 7) are acquired from the hard disk 14 (Step S22). Thereafter, reading of the contents data is carried out in accordance with the setting contents.

First, it is determined whether motion image data is set for reading or not (Step S23). If the motion image data is set for reading, the file D2 of motion image data is read from the memory card 9. The read motion image data is converted into a format appropriate for registration and registered in the database 142 of the hard disk 14 (Step S24). On the other hand, if the motion image data is set for non-reading, no motion image data is read from the memory card 9.

Subsequently, it is determined whether sound data is set for reading or not (Step S25). If the sound data is set for reading, the file D3 of sound data is read from the memory card 9. The read sound data is converted into a format appropriate for registration and registered in the database 142 of the hard disk 14 (Step S26). On the other hand, if the sound data is set for non-reading, no sound data is read from the memory card 9.

Subsequently, it is determined whether constantly recorded data is set for reading or not (Step S27). If the constantly recorded data is set for reading, the file D4 of constantly recorded data is read from the memory card 9. The read constantly recorded data is converted into a format appropriate for registration and registered in the database 142 of the hard disk 14 (Step S28). On the other hand, if the constantly recorded data is set for non-reading, no constantly recorded data is read from the memory card 9.

As described above, since only contents data of the kind that is set for reading is read, reading of contents data of which the data size is relatively large can be omitted according to need. Thus, the time associated with the data latch processing in the data management device 1 can be shortened greatly. Although the operation data is configured to be always read regardless of the user setting, since the operation data has a relatively small data size, it will not have a great influence on the time associated with the data latch processing.

Subsequently, data read from the memory card 9 by the above-described processing is erased from the memory card 9. By this operation, duplicate reading of the same data by the data management device 1 later can be prevented. Since the operation data is configured to be always read regardless of the user setting, the file of operation data will always be erased from the memory card 9. Therefore, by checking the presence of the file of operation data in the memory card 9 later, it can be determined whether the data latch processing of the memory card 9 has been completed or not.

At the time of erasing data, first, it is determined whether all kinds of data among the four kinds of data of the operation data, motion image data, sound data, and constantly recorded data recorded in the memory card 9 have been read or not (Step S29).

When at least one kind of contents data is set for non-reading, it is in the state where a part of the contents data of the memory card 9 is not read. In such a case (No in Step 29) where at least a part of data of the memory card 9 is not read, the file D1 of operation data and the files of the read contents data (namely, the contents data of the kind that is set for reading) are deleted from the memory card 9 (Step S31).

In this state, the files of non-read contents data (namely, the contents data of the kind that is set for non-reading) remain in the memory card 9. Such contents data (hereinafter referred to as “remaining data”) remaining in the memory card 9 can be read by the data management device 1 or the like later according to need.

However, since the file D1 of the operation data was deleted, the specific data for specifying the situation of the vehicle B in which data reading was carried out (such as operation start time, driver changing time, identification information of the vehicle B, or identification information of the driver) is also deleted from the memory card 9. Therefore, regarding the remaining data, it is unable to specify the situation of the vehicle B when the data was acquired. In order to prevent this, a specific data file representing only the specific data in the file of operation data subjected to deleting in Step S31 is created and recorded in the memory card 9 (Step S32).

In this way, the remaining data and the specific data are correlated, and the situation of the vehicle B when the remaining data was acquired can be specified later even when the remaining data is read from the memory card 9. Preferably, the specific data includes data representing the situation of the vehicle B such as the position, speed, and acceleration of the vehicle B at the point of time when each remaining item of data was recorded, in addition to the operation start time, the driver changing time, the identification information of the vehicle B, and the driver identification information.

On the other hand, when all kinds of data are read (Yes in Step S29), all data erasing processing is carried out in which all of the data in the memory card 9 is erased (Step S30).

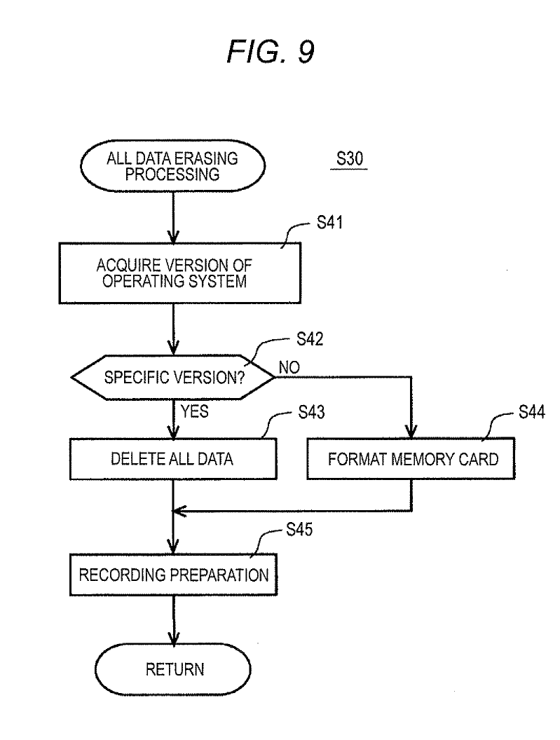

FIG. 9 is a diagram showing a detailed flow of this all data erasing processing (Step S30). First, the version of an operating system running on the data management device 1 is checked (Step S41).

When all of the data in the memory card 9 is erased, two methods, one method of formatting the memory card 9 and the other method of deleting files of all of the recorded data, may be considered. Among these methods, the method of formatting the memory card 9 has variations in terms of detailed processing contents and differs in accordance with an operating system. Therefore, when the formatting method is used, the time required for the formatting processing differs in accordance with the version of the operating system. As a result, when an operating system has a specific version, the formatting processing may take much time.

For this reason, if the operating system has such a specific version (Yes in Step S42), all of the data in the memory card 9 are erased by the method of deleting files without using the formatting method (Step S43). For example, if a FAT file system is used as a file system, all of the data are deleted by overwriting the contents of directory entries and FAT.

On the other hand, if the operating system does not have the specific version (No in Step S42), the formatting of the memory card 9 is carried out by the function of the operating system, and all of the data in the memory card 9 is erased (Step S44). By selecting the method of erasing data in accordance with an operating system, the processing time associated with erasing of data in the memory card 9 can be shortened.

When all of the data in the memory card 9 is deleted, recording preparation processing is carried out for the memory card 9 to be used for recording during the subsequent operation (Step S45). Specifically, the setup file D0 representing the setup parameters is recorded in the memory card 9.

As described above, in the data management device 1 of this embodiment, during the data latch processing, only the contents data of the kind that is set for reading among the contents data is read together with the operation data. Therefore, reading of contents data which includes images and sound and has a relatively large data size can be omitted according to need, and processing time required for reading of the memory card 9 can be shortened greatly. Thus, even when there are many vehicles B belonging to the establishment A, the data latching operation does not take much time, and work efficiency can be improved.

Moreover, since the operation data read by the data management device 1 is deleted from the memory card 9, whether or not the data latch processing of the memory card 9 has been completed can be confirmed based on the presence of the operation data in the memory card 9. Furthermore, since the read data is deleted from the memory card 9, duplicate reading of the same data by the data management device 1 can be prevented.

Moreover, in the data management device 1, even when the file of the operation data is deleted, the specific data file representing the specific data for specifying the situation of the vehicle B in which data recording is carried out is created in the memory card 9. Therefore, regarding contents data (remaining data) remaining in the memory card 9 after the data latch processing is carried out, the situation of the vehicle B when the remaining data was acquired can be grasped later. A case where the file of operation data during the subsequent operations is recorded in the memory card 9 in which the specific data file is recorded may occur. However, in this case, the operation data may be prioritized.

### 2. Second Embodiment

Next, a second embodiment will be described. In the first embodiment, the specific data file is created in order to specify later the situation of the vehicle B when the remaining data was acquired. In contrast, in the second embodiment, the drive recorder 2 is configured to embed the specific data in a predetermined region of contents data at the time of creating the contents data in the memory card 9.

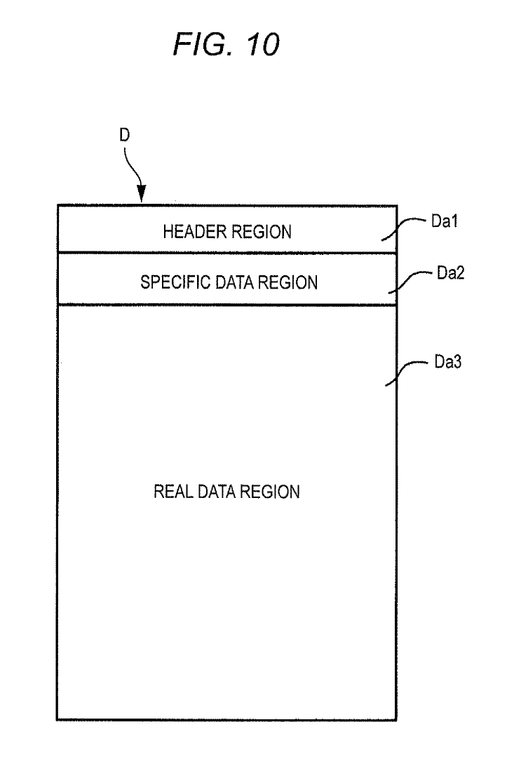

FIG. 10 is a diagram showing an example of a data region in the file D of contents data in which the specific data is embedded. As shown in the figure, the file D of contents data has a specific data region Da2 between a header region Da1 and a real data region Da3. The specific data for specifying the situation of the vehicle B in which the contents data was acquired (such as operation start time, driver changing time, identification information of the vehicle B, and driver identification information) is recorded in the specific data region Da2.

The specific data region Da2 is disposed right after the header region Da1. Therefore, a device that reads the file D of contents data can easily acquire the specific data from the file D. That is, the situation of the vehicle B in which the contents data was acquired can be specified by only the file D of the contents data.

Therefore, since the specific data can be acquired from the file itself even when contents data having such a file format remains as the remaining data, the situation of the vehicle B when the contents data was acquired can be grasped later.

### 3. Third Embodiment

Next, a third embodiment will be described. In the first embodiment, when motion image data is set for non-reading, all of the motion image data are not read without discrimination. However, important data representing the situation of an accident is also present in the motion image data. Therefore, in the third embodiment, even when motion image data is set for non-reading, motion image data of which the acquisition situation meets a predetermined condition is exceptionally read.

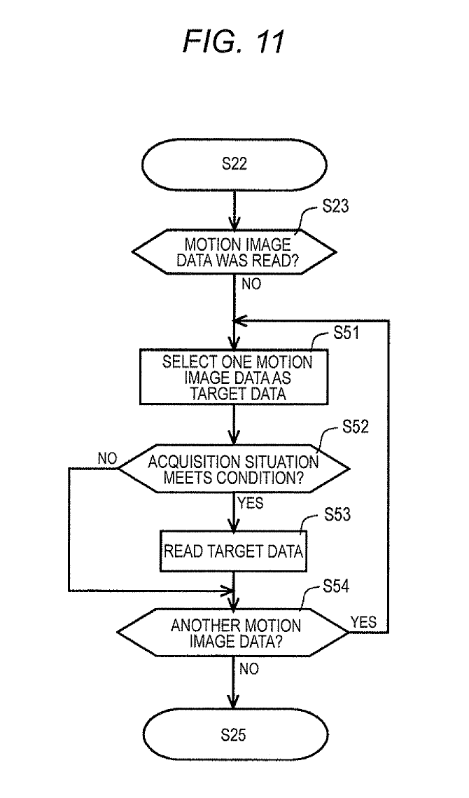

The third embodiment is different from the first embodiment only in the data latch processing. Data latch processing of the third embodiment is different from the data latch processing shown in FIG. 8 in the processing when motion image data is set for non-reading (the case of No in Step S23). FIG. 11 is a diagram showing a flow of processing of this different part.

When motion image data is set for non-reading, first, one motion image data among the motion image data stored in the memory card 9 is selected as target data to be processed (Step S51).

Subsequently, operation data (such as the position, speed, and acceleration of the vehicle B) when the target data was acquired is read from the file D1, and it is determined whether or not the situation of the vehicle B when the target data was acquired meets a predetermined condition (Step S52). For example, it is determined whether or not the situation corresponds to the condition (A) wherein the probability of occurrence of a collision accident is high among the above-mentioned conditions (A) to (D) which are the acquisition conditions of the motion image data on the drive recorder 2.

When the situation of the vehicle B when the target data was acquired meets the predetermined condition, the target data is regarded as important data and read from the memory card 9 and registered in the database 142 of the hard disk 14 (Step S53). On the other hand, when the situation of the vehicle B when the target data was acquired does not meet the predetermined condition, the target data is not read.

In this manner, when processing of one motion image data is completed, it is determined whether or not motion image data which was not processed and selected as target data is present in the memory card 9 (Step S54). When such data is present (Yes in Step S54), the next one motion image data is selected as new target data (Step S51), and reading is carried out in accordance with the situation of the vehicle B when the target data was acquired. Such processing is repeatedly carried out, and finally all of the motion image data in the memory card 9 is processed, such that only the motion image data of which the acquisition situation meets the predetermined condition is read.

As described above, even when motion image data is set for non-reading, by exceptionally reading motion image data of which the acquisition situation meets the predetermined condition, important motion image data can be recorded in the data management device 1.

In this embodiment, although the exceptional reading operation is carried out with respect only to the motion image data, the exceptional reading operation may also be carried out with respect to sound data and constantly recorded data depending on the result of determination as to whether or not the acquisition situation meets the predetermined condition. In addition, the condition on which the exceptional reading operation is carried out is not limited to the above-described example but may be set arbitrarily regardless of the acquisition condition of the motion image data on the drive recorder 2. For example, a stricter condition than the condition (A) which is the acquisition condition of the motion image data on the drive recorder 2 (for example, when an acceleration equal to or higher than 0.60 G is continuously detected for 100 milliseconds or more) may be used.

### 4. Fourth Embodiment

Next, a fourth embodiment will be described. In the first embodiment, the method of erasing all of the data in the memory card 9 is selected in accordance with the version of the operating system. In contrast, in the fourth embodiment, the method of erasing all of the data in the memory card 9 is selected in accordance with the number of reading operations performed on the memory card 9.

In this embodiment, identification information (ID code) is assigned to each of the memory cards 9 handled in the drive recorder system 100. Counters that represent the number of executions of data latch processing are set for each piece of the identification information (ID codes) of the memory cards 9, and the counters are recorded in the hard disk 14 of the data management device 1. Every time the data management device 1 carries out the data latch processing, “1” is added to the counter of the memory card 9 to be processed.

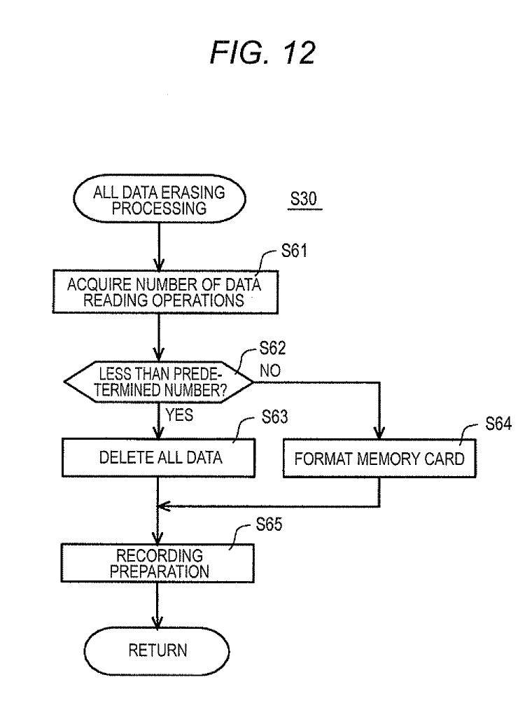

FIG. 12 is a diagram showing a detailed flow of all data erasing processing (Step S30 of FIG. 8) in the fourth embodiment. First, the value of the counter of the memory card 9 to be processed is acquired from the hard disk 14. That is, the number of reading operations that the data management device 1 performed on the memory card 9 is acquired (Step S61).

If the value of this counter is less than a predetermined number (for example, 10 times) (Yes in Step S62), all of the data in the memory card 9 are erased by the method of deleting files without using the formatting method (Step S63). Thus, the processing is carried out in a relatively short period of time.

On the other hand, if the value of the counter is equal to or larger than the predetermined number (for example, 10 times) (No in Step S62), the memory card 9 is formatted, and all of the data in the memory card 9 are erased (Step S64). Moreover, the value of the counter of the memory card 9 returns to “0”.

When all of the data in the memory card 9 are deleted, recording preparation processing is carried out for the memory card 9 to be used for recording during the subsequent operation (Step S65).

By such processing, in the fourth embodiment, whenever the reading of the memory card 9 is carried out for 10 times, the memory card 9 is formatted. If writing and deleting of files are repeated without formatting the memory card 9, there is a possibility that defects may occur in a part of the memory area and eventually lead to destruction of data. In this embodiment, since the memory card 9 is periodically formatted in accordance with the number of reading operations, destruction of data can be prevented.

In the above embodiment, although the counter representing the number of reading operations performed on the memory card 9 is recorded in the data management device 1, the counter may be recorded in the memory card 9 itself.

Moreover, in the above embodiment, although the formatting is automatically carried out when the value of the counter is equal to or larger than the predetermined number, a dialog that urges the user to perform formatting may be displayed.

Furthermore, in the above embodiment, the formatting is carried out during the all data erasing processing (Step S30 of FIG. 8) in which all of the data in the memory card 9 is erased. In contrast, the formatting may be carried out during the processing (Step S31 of FIG. 8) in which only the read data is erased, when the value of the counter is equal to or larger than the predetermined number. In this case, first, contents data which is not read is temporarily copied to the hard disk 14. Subsequently, the memory card 9 is formatted so that all of the data in the memory card 9 is erased. After that, the non-read contents data copied to the hard disk 14 is rewritten to the memory card 9. Moreover, in this case, a dialog that prompts the user to perform formatting may be displayed without carrying out the formatting.

### 5. Modifications

Although the embodiments of the invention have been described, the invention is not limited to the foregoing embodiments, and various modifications may be made. Hereinafter, such modifications will be described. All of the embodiments including the foregoing embodiments and the following embodiments may be appropriately combined with each other.

Although in the foregoing embodiments, a case has been described where the drive recorder system 100 is applied to a company which carries out operations using taxis, the invention may be applied to any company insofar as the company carries out operations using a plurality of vehicles for commercial use, such as trucks, buses, and commercial vehicles.

Although in the foregoing embodiments, a case has been described where the memory card 9 is used as a portable recording medium, a recording disk, such as a readable/writable CD-ROM, a portable hard disk, or the like may be used.

Although in the foregoing embodiments, a case has been described where various functions are implemented by software through the arithmetic processing of the CPU in accordance with the program, some of the functions may be implemented by electrical hardware circuits.

What is claimed is:

1. A data management device that manages data recorded by a drive recorder mounted in each of a plurality of vehicles, wherein the drive recorder records operation data which represents a traveling situation of the vehicle and which does not include images and sounds and a plurality of kinds of contents data which includes at least one of images and sounds in one portable recording medium, the data management device comprising:
a receiving unit that receives a user setting regarding reading/non-reading of the contents data for each of the plurality of kinds;
a storage device that integrates and stores data obtained by the drive recorder of each of the plurality of vehicles; and
a reading unit that reads the operation data and the contents data of a kind that is set for reading by the user setting among the plurality of kinds, among contents recorded in the recording medium by the drive recorder of the vehicle after completion of operation of each of the plurality of vehicles and records the operation data and the contents data in the storage device.

2. The data management device as set froth in claim 1, further comprising a deleting unit that deletes the operation data read by the reading unit from the recording medium.

3. The data management device as set forth in claim 1, further comprising a deleting unit that deletes the contents recorded in the recording medium and read by the reading unit.

4. The data management device as set forth in claim 2,
wherein the operation data includes specific data for specifying a situation of the vehicle from which the contents data is acquired, and
wherein the data management device further comprises a recording unit that records the specific data included in the operation data in the recording medium when the operation data is deleted from the recording medium.

5. The data management device as set forth in claim 3,
wherein the operation data includes specific data for specifying a situation of the vehicle from which the contents data is acquired, and
wherein the data management device further comprises a recording unit that records the specific data included in the operation data in the recording medium when the operation data is deleted from the recording medium.

6. The data management device as set forth in claim 2, wherein the contents data includes specific data for specifying a situation of the vehicle from which the contents data is acquired.

7. The data management device as set forth in claim 3, wherein the contents data includes specific data for specifying a situation of the vehicle from which the contents data is acquired.

8. The data management device as set forth in claim 1, wherein the reading unit further reads contents data of which an acquisition situation meets a predetermined condition among the contents data of a kind that is set for non-reading by the user setting among the plurality of kinds.

9. The data management device as set forth in claim 1, further comprising an erasing unit that erases all of the contents data in the recording medium by selectively using a method of formatting the recording medium and a method of deleting files recorded in the recording medium.

10. The data management device as set forth in claim 7, wherein the erasing unit selects one of the two methods in accordance with an operating system that runs on the data management device.

11. The data management device as set forth in claim 7, wherein the erasing unit selects one of the two methods in accordance with the number of reading operations that the reading unit performed on the recording medium which is subjected to erasing.

12. A method of reading data recorded by a drive recorder mounted in each of a plurality of vehicles, wherein the drive recorder records operation data which represents a traveling situation of the vehicle and which does not include images and sounds and a plurality of kinds of contents data which includes at least one of images and sounds in one portable recording medium, the method comprising:
receiving a user setting regarding reading/non-reading of the contents data for each of the plurality of kinds;
reading the operation data and the contents data of a kind that is set for reading by the user setting among the plurality of kinds, among contents recorded in the recording medium by the drive recorder of the vehicle after completion of operation of each of the plurality of vehicles; and
recording the operation data and the contents data in a storage device integrates and stores data obtained by the drive recorder of each of the plurality of vehicles.

13. A computer-readable medium recording a program causing a computer to execute the method as set forth in claim 12.
